(19) United States
(12) Patent Application Publication
(10) Pub. No.: US 2023/0229120 A1
(43) Pub. Date: Jul. 20, 2023

(54) METHOD FOR GENERATING A DIGITAL MODEL-BASED REPRESENTATION OF A VEHICLE

(71) Applicant: Robert Bosch GmbH, Stuttgart (DE)

(72) Inventor: Hans-Leo Ross, Lorsch (DE)

(21) Appl. No.: 18/151,613

(22) Filed: Jan. 9, 2023

(30) Foreign Application Priority Data
Jan. 14, 2022 (DE) 102022 200 383.7

(51) Int. Cl. G05B 13/04; G07C 5/04; G05B 13/02; H04R 1/40; H04R 3/00

(52) U.S. Cl. CPC G05B 13/04; G05B 13/027; G07C 5/04; H04R 1/406; H04R 3/005; H04R 2499/13

(57) ABSTRACT

A method for generating a digital model-based representation of a vehicle. The method includes: receiving sensor data of a plurality of acoustic sensors of a vehicle, wherein the sensor data describes sounds of the vehicle and/or sounds of an environment of the vehicle, and wherein the sensor data has been recorded for a plurality of trips of the vehicle; evaluating the sensor data and the creation of relations between the received sounds of the vehicle and/or the environment and the particular sound-causing statuses of the vehicle and/or the environment; and storing in a model-based representation of the vehicle and/or the environment, the determined relations between the sounds of the vehicle and/or the environment in a model-based representation of the vehicle.

### CROSS REFERENCE

The present application claims the benefit under 35 U.S.C. § 119 of German Patent Application No. DE 10 2022 200 383.7 filed on Jan. 14, 2022, which is expressly incorporated herein by reference in its entirety.

### FIELD

The present invention relates to a method for generating a digital model-based representation of a vehicle and a method for controlling a vehicle.

### BACKGROUND INFORMATION

For the control of vehicles, in particular autonomously driving vehicles, a knowledge of states of the vehicle as well as of the environment of the vehicle that is as comprehensive as possible is crucially important.

It is therefore an object of the present invention to provide an improved method of generating a digital model-based representation of a vehicle and an improved method of controlling a vehicle.

This task is accomplished by an improved method of generating a digital model-based representation of a vehicle and an improved method of controlling a vehicle according to the present invention. Advantageous configurations are the present invention are disclosed herein.

According to an aspect of the present invention, a method of generating a digital model-based representation of a vehicle is provided. According to an example embodiment of the present invention, the method comprises:
receiving sensor data from a plurality of acoustic sensors of a vehicle, wherein the sensor data describe sounds of the vehicle and/or sounds of an environment of the vehicle, and wherein the sensor data were recorded for a plurality of trips of the vehicle;
evaluating the sensor data and creating relations between the recorded sounds of the vehicle and/or of the environment and the states of the vehicle and/or of the environment causing the respective sounds; and
storing, in a model-based representation of the vehicle, the determined relations between the sounds of the vehicle and/or of the environment and the respective states of the vehicle and/or of the environment.

This may achieve the technical advantage that an improved method of generating a digital model-based representation of a vehicle can be provided. For this purpose sensor data of a plurality of acoustic sensors of a vehicle are received, wherein the sensor data describe sounds of the vehicle and/or sounds of the environment of the vehicle. For this purpose, the sensor data were recorded by a plurality of trips of the vehicle, e.g., along different travel lanes. When generating the model-based representation of the vehicle, the sensor data of the acoustic sensors are evaluated and relations are established between the recorded sounds of the sensor data, which respectively describe sounds of the vehicle and/or of the environment of the vehicle, and states of the vehicle and/or of the environment that cause the respective sounds. The relations created in this way between the sounds of the vehicle or of the environment recorded by the acoustic sensors and the sound-causing states of the vehicle or of the environment are subsequently stored as representation of the vehicle based on the acoustic data of the acoustic sensors. As a result of this, a model-based representation of the vehicle based on acoustic data can be provided. By means of the model-based representation of the vehicle, based on data from acoustic sensors of the vehicle during a trip of the vehicle, conclusions can be drawn about states of the vehicle and/or states of the environment of the vehicle.

According to one embodiment of the present invention, the sounds of the vehicle include: sounds of a motor and/or a transmission and/or a chassis and/or a shock absorption and/or a wheel suspension and/or of brakes, and/or of tires and/or a body of the vehicle, and wherein states of the vehicle include: functional states of the motor and/or the transmission and/or the chassis and/or the shock absorption and/or the wheel suspension and/or the tires and/or the body and/or a speed and/or a loading state of the vehicle and/or a rolling resistance of the tires on a roadway and a state of the roadway and/or a coating of the body with moisture, snow, hail, dust, leaves.

By this, the technical advantage may be achieved that a plurality of different sounds of the vehicle may be considered by corresponding measurement of the acoustic sensor data. Accordingly, a plurality of different states of the vehicle may be determined based on the respective acoustic data of the acoustic sensors of the vehicle. The states of the vehicle can thereby determine the functional capability of the motor, the transmission, the chassis, the shock absorption, the wheel suspension, the tires, the body as well as speeds, loading states, rolling resistances, tires or coating the body with moisture, snow, hail, dust or leaves. Thus, based on the model-based representation of the vehicle, a comprehensive state of the vehicle may be determined.

According to one embodiment of the present invention, the sounds of the environment include: Sounds of other vehicles, sounds of pedestrians, sounds of animals, sounds of the vehicle reflected from surrounding buildings or vegetation, sounds of precipitation, snowfall, hail, wind, and wherein states of the environment of the vehicle include: a presence of vehicles, pedestrians, buildings, vegetation, of precipitation, hail, snow.

This may achieve a technical advantage that a plurality of different sounds within the environment of a vehicle can be considered for model-based representation of the vehicle. A plurality of different states of the environment of the vehicle may be determined based on the various sounds recorded by the respective acoustic sensors arranged on the vehicle. The states of the environment may include the presence of various objects that may be classified based on the characteristic sounds, as well as various weather conditions that are also taken into account based on the characteristic sounds that they cause, for example, on the body of the vehicle. With this, a comprehensive model-based representation of the vehicle based on acoustic data of a plurality of acoustic sensors of a vehicle can be provided that allows a comprehensive description of different states of the environment of the vehicle.

According to one embodiment of the present invention, a detection of the objects in the environment includes a position determination of the objects in the environment and/or a determination of a distance and/or a speed of the objects relative to the vehicle and/or a characterization of the objects.

This may achieve the technical advantage that detailed object detection of objects within the environment of the vehicle may be included in the model-based representation of the vehicle based on the respective characteristic sounds of the objects captured by the corresponding sensor data of the acoustic sensors of the vehicle. With this, a precise model-based representation of the vehicle can be achieved that allows a detailed description of the environment of the vehicle based on acoustic data from acoustic sensors of the vehicle.

According to one embodiment of the present invention, sensor data include acoustic data of a plurality of microphones and/or data of a plurality of ultrasonic sensors.

This may achieve a technical advantage that precise acoustic data of the acoustic sensors can be used to generate a model-based representation of the vehicle. Through the microphones, detailed sounds of both the vehicle and the environment, in the form of the acoustic data, can enter into the generation of the model-based representation. By using ultrasonic sensors, distance information or speed information of objects within the environment can also enter into the generation of the model-based representation of the vehicle. With this, a further specification of the description of the states particularly of the environment of the vehicle can be achieved.

According to one example embodiment of the present invention, establishing the relations between the sounds of the vehicle and/or environment and the respective states of the vehicle and/or environment comprises applying machine learning techniques to the sensor data, wherein storing the relation is comprised by storing a correspondingly trained artificial intelligence or a plurality of correspondingly trained artificial intelligences.

With this, the technical advantage may be achieved that precise, fast, and reliable generation of the model-based representation of the vehicle is enabled. By using machine learning techniques, the relations of the respective determined sounds of the acoustic data and the states causing the sounds of both the vehicle and the environment of the vehicle based on the recorded acoustic data of the acoustic sensors, may be determined by a corresponding training of the artificial intelligences used. By the correspondingly trained artificial intelligences, which represent the respective stored relations of the model-based representation of the vehicle, upon successful generation of the model-based representation of the vehicle, it is further possible to achieve a fast and reliable determination of the states of the vehicle or of the environment by executing the respective trained neural network on the acoustic data of the acoustic sensors recorded during travel of the vehicle.

According to one embodiment of the present invention, the model-based representation of the vehicle is configured as a digital twin of the vehicle based on the acoustic sensor data.

With this, the technical advantage may be achieved that a comprehensive description of the vehicle or statuses of the vehicle and/or statuses of the environment of the vehicle may be provided by model-based representation of the vehicle.

In another aspect of the present invention, a method of controlling a vehicle is provided. According to an example embodiment of the present invention, the method comprises:
receiving sensor data of a plurality of acoustic sensors of a vehicle, wherein the sensor data describe vehicle sounds and/or sounds of an environment of the vehicle;
performing a model-based representation of the vehicle on the acoustic sensor data, wherein the model-based representation of the vehicle is generated according to the method of generating a digital model-based representation of a vehicle according to any one of the above-described embodiments;
determining a state of the vehicle and/or a state of the environment of the vehicle based on the acoustic sensor data of the vehicle and the relations stored in the model-based representation of the vehicle; and
outputting control signals for controlling the vehicle by taking into account the determined state of the vehicle and/or the state of the environment of the vehicle.

This may provide an improved method of controlling a vehicle in which a model-based representation of the vehicle with the aforementioned technical advantages is utilized.

In another aspect of the present invention, a computing unit is provided that is configured to perform the method of generating a digital model-based representation of a vehicle according to any one of the above-described embodiments and/or the method of controlling a vehicle.

According to another aspect of the present invention, a computer program product is provided comprising instructions that, when executed by a data processing entity, cause the program to perform the method of generating a digital model-based representation of a vehicle according to any one of the above-described embodiments and/or the method of controlling a vehicle.

Embodiment examples of the present invention will be explained in more detail with reference to the figures and the following description.

### BRIEF DESCRIPTION OF THE DRAWINGS

FIG. 1 shows a schematic representation of a system for generating a digital model-based representation of a vehicle, according to an example embodiment of the present invention.

FIG. 2 shows a flow chart of a method for generating a digital model-based representation of a vehicle, according to an example embodiment of the present invention..

FIG. 3 shows a flow chart of a method for controlling a vehicle, according to an example embodiment of the present invention.

FIG. 4 shows a schematic illustration of a computer program product, according to an example embodiment of the present invention.

### DETAILED DESCRIPTION OF EXAMPLE EMBODIMENTS

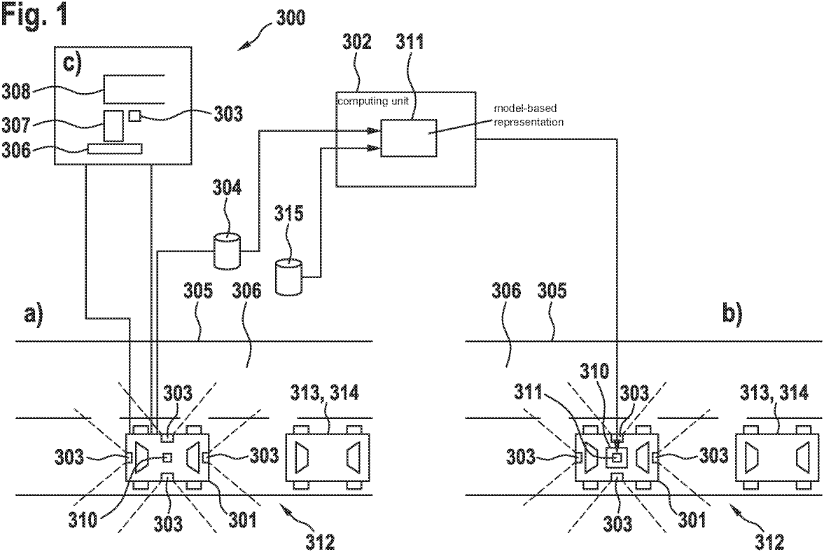

FIG. 1 shows a schematic illustration of a system 300 for generating a digital model-based representation 311 of a vehicle 301.

FIG. 1 shows in diagram a) a graphic illustration of the method according to the present invention for generating a model-based representation 311 of a vehicle 301. In diagram b) of FIG. 1, on the other hand, a graphical illustration of the method according to the present invention for controlling a vehicle is provided.

In diagram a), the scene of a vehicle 301 traveling in a lane 305 is shown. The vehicle 301 includes a plurality of acoustic sensors 303 formed at various locations of the vehicle 301. For example, the acoustic sensors 303 may be configured as microphones or ultrasonic sensors. The acoustic sensors 303 may be arranged on the vehicle such that these sounds within the vehicle or sounds within an environment 312 of the vehicle may be recorded. Distances or speeds of objects in the environment of the vehicle 301 may be determined by the ultrasonic sensors.

In order to generate a model-based representation 311 of the vehicle 301 based on the acoustic data of the acoustic sensors 303 of the vehicle 301, a plurality of different trips along different travel lanes 305 are performed by the vehicle 301, according to the present invention. For example, the trips may be configured as test drives and serve solely to record corresponding data through the acoustic sensors 303 of the vehicle 301. Thus, based on the plurality of trips, corresponding sensor data 304 are recorded by the acoustic sensors 303 formed at various locations in the vehicle 301. Various sounds may be recorded within the vehicle or environment of the vehicle by the sensor data 304. Alternatively or additionally, when the acoustic sensors 303 are configured as ultrasonic sensors, distance or speed information of objects 313 situated in the environment 312 relative to the vehicle 301 is determined by the sensor date 304.

Depending on the placement of the acoustic sensors 303 at different positions of the vehicle, different sounds of different parts of the vehicle may be recorded by the measurements of the acoustic sensors. For example, sounds of the motor, transmission, chassis, shock absorption, wheel suspension, brakes, tires, and/or body of the vehicle may be recorded. In graph c) of FIG. 1, a corresponding arrangement of an acoustic sensor 303 in the immediate vicinity of a tire 307 or a chassis 308 of the vehicle 301 is shown in enlarged fashion. Thus, the measurements taken by the acoustic sensor 303 arranged proximate to the tire 307 may capture, for example, tire sounds of the tire 307 that occur during travel of the vehicle 301. By acoustic sensors 303 arranged at other locations of the vehicle 301, sounds from other components, such as the motor or the transmission of the vehicle 301 may be recorded during travel.

By acoustic sensors 303 arranged correspondingly towards the environment 312 of the vehicle 301, sounds within the environment, for example by objects 313 within the environment, can be recorded during travel. For example, in FIG. 1, another vehicle 314 is situated within the environment 312. By corresponding acoustical recording of the sounds of the vehicle 314, object detection of the further vehicle 314 can be performed by corresponding data processing and evaluation of the sensor data 304. Alternatively, or additionally, by forming the acoustic sensors 303 facing into the environment 312 of the vehicle 301 as ultrasonic sensors, range or speed information of the objects 313 in the environment 312 of the vehicle 301 can be recorded.

To evaluate the sensor data 304 of the plurality of acoustic sensors 303 recorded during the test trips of the vehicle 301 and to generate a model-based representation 311 of the vehicle 301, the sensor data 304 are transmitted to a computing unit 302. The computing unit 302 is configured to perform the method according to the present invention of generating a model-based representation 311 of the vehicle 301. In addition to the sensor data 304 of the plurality of acoustic sensors 303, state data 315 are also provided. State data 315 describe states of the vehicle 301 or states of the environment 312 of the vehicle 301 that the vehicle 301 or the environment of the vehicle experienced during the recording of the sensor data 304 by the acoustic sensors 303.

Based on the sensor data 304 and the state data 315, a plurality of relations between the sensor data 304 and the corresponding state data 315 may be achieved to generate the model-based representation 311 of the vehicle 301. The relations between the sensor data 304 and the state data 315 describe connections between the sounds of the vehicle 301 or of the environment 312 recorded in the sensor data 304 and the states of the vehicle 301 or environment 312 causing the sounds of the vehicle 301 and the environment 312, respectively.

For the example of the acoustic sensor 303 arranged near the tire 307 of the vehicle 301, the state data 315 may include a tire pressure or model of tire 307 or information relating to the roadway surface 306 of the travel lane 305. Thus, by evaluating the corresponding sensor data 304 of the acoustic sensor 303 arranged on the tire 307 and the corresponding state data 315, relations may be established between tire sounds of the tire 307 recorded by the respective acoustic sensor 303 and, for example, the tire pressure of the tire 307 or the tire model of the tire 307 or the respective lane surface 306 of lane 305, which was traveled by the vehicle 301 at the time of recording the sensor data 304. Thus, by way of the corresponding relations between the recorded tire sounds and the respective state of the tire 307, upon successful generation of the model-based representation 311 of the vehicle 301 based on the tire sounds of the tire 307 recorded by the acoustic sensor 303, it is possible to draw conclusions as to the state of the tire 307. Thus, speed information of the vehicle included in the state data 315 and/or information regarding the lane surface 306 can be considered as well.

Analogously, the sensor data 304 of acoustic sensors 303 arranged on the motor of the vehicle and state data 315 comprising motor states, may be used to establish corresponding relations between the motor sounds recorded by the sensor data 304 and corresponding motor states.

The established relations yield mappings between the sounds of the sensor data 304 and the states of the status data 315. The mappings can be used to determine corresponding states based on recorded sensor data 304 upon successful generation of the model-based representation 311.

Analogously, via sounds from the environment 312 recorded by corresponding sensor data 304 from the acoustic sensors 303 facing the environment 312 and state data 315 describing environmental states, which comprise information regarding buildings, vegetation, or road routing obtained from representations of the respective travel lanes 305, it is possible to derive corresponding relations between the sounds of the environment 313 recorded in the sensor data 304 and the states of the environment 312 described in the state data 315.

For the shown example of the further vehicle 314 located in travel lane 305, state data 315 may include information of a camera data-based object detection, in which it was possible to detect the further vehicle 314 traveling in lane 305. The sounds recorded in the corresponding sensor data 304 within the environment 312 may thus be uniquely associated with the respective environmental state 312, taking into account the state data 315 describing the further vehicle 314, wherein, for example, the state of the environment 312 describes the presence of the further vehicle 314.

Thus, by evaluating the sensor data 304 recorded during test drives and the state data 315 accordingly provided, the relations between vehicle sounds and/or environmental sound recorded in the sensor data 304 and the respective states of the vehicle and/or states of the environment can be determined. The determined and stored relations between recorded vehicle or environmental sounds and the respectively associated states of the vehicle or of the environment represent, according to the present invention, the model-based representation 311 of the vehicle 301.

According to one embodiment, the evaluation of the sensor data 304 or state data 315 and the generation of the relations between the recorded vehicle or environmental sound and the respectively associated states of the vehicle or of the environment may be achieved by applying machine learning techniques. For example, for the plurality of acoustic sensors 303, a correspondingly constructed neural network, or a plurality of neural networks, may be used to generate the relations between the vehicle or environmental sounds recorded in the sensor data 304 and the respective states of the vehicle or of the environment. For a corresponding training of the neural network or the plurality of neural networks, the relations between the recorded sounds and the states of the vehicle or of the environment can be generated.

Relations between distance and speed information and corresponding states of the environment can be determined analogously based on distance or speed information of sensor data from acoustic sensors 303 configured as ultrasonic sensors.

According to one embodiment, the sounds of the vehicle recorded by the sensor data 304 may include sounds of a motor, a transmission, a chassis, a shock absorption, a wheel suspension, brakes, tires, and a body of the vehicle, as well as other sounds of other components of the vehicle. The respective states of the vehicle described in the state data 315 can in this case include functional states of the motor, the transmission, the chassis, the shock absorption, the wheel suspension, the tires, the body, as well as information regarding the speed, the loading state, the rolling resistance of the tires 307 on a travel lane 305, as well as a state of the travel lane 305 or information regarding a coating of the body with moisture, snow, hail, leaves, or dust or other states of the vehicle 301.

According to one embodiment, the environmental sounds 312 recorded by the sensor data 304 of the acoustic sensors 303 may include sounds of further vehicles 314, sounds of pedestrians, animals, sounds of the vehicle 301 reflected by buildings or vegetation situated in the environment 312, sounds of precipitation, snowfall, hail, wind, and other sounds detectable in the environment of the vehicle 312. The states of the environment 312 may therefore include the presence of objects 313, such as other vehicles 314, pedestrians, buildings, vegetation, or the presence of specific weather conditions such as precipitation, hail, snowfall, or other states of the environment.

Diagram b) of FIG. 1 shows a graphical representation of the method according to the present invention for controlling a vehicle 301. Controlling the vehicle 301 is performed based on the sensor data 304 of the plurality of acoustic sensors 303 of the vehicle 301 and taking into account the model-based representation 311 of the vehicle 301 generated as described above. Upon successful generation of the model-based representation 311 of the vehicle 301, it is installed in a computing unit 310 of the vehicle 301. To control the vehicle 301, a plurality of sensor data 304 of the plurality of acoustic sensors 303 are recorded during travel of the vehicle 301, according to the present invention. As described above, the sensor data 304 may include sounds of the vehicle, or sounds of various components of the vehicle 301, and/or sounds of the environment of the vehicle 312, and/or distance or speed information of objects 313 situated in the environment 312 of a vehicle 301. According to the present invention, the model-based representation 311 of the vehicle 301 generated accordingly comprises relations between vehicle and environmental sounds and states of the vehicle 301 or of the environment 312, respectively, which are the cause for the accordingly recorded vehicle or environmental sounds. Thus, by applying the correspondingly generated model-based representation 311 of the vehicle 301 on the sensor data 304 recorded during the travel of the vehicle 301, the states of the vehicle 301 or of the environment 312 during the travel of the vehicle 301 can be determined by the relations between vehicle and environmental sound and corresponding states of the vehicle 301 or of the environment 312 stored in the model-based representation 311 of the vehicle 301. Thus, by outputting corresponding control signals, taking into account the model-based representation 311 of the vehicle 301 and the sensor data 304 of the acoustic sensors 303 of the vehicle 301 recorded during travel, a control of the vehicle 301 can be effected in which the states of the vehicle 301 and of the environment 312 determined by the model-based representation 311 of the vehicle 301 can be considered.

According to one embodiment, the model-based representation 311 can be configured as a digital twin of the vehicle 301.

In the embodiment shown, the computing unit 302 configured to generate the model-based representation 311 of the vehicle 301 is configured as an external computing unit. For example, this may be configured in the form of a data center to create the model-based representations 311, which is structured as, for example, a corresponding server unit that can communicate with the respective vehicle 301 via data transmission. In the embodiment shown, the computing unit 310 configured to execute the generated model-based representation 311 of the vehicle 301 is configured in the vehicle 301. Alternatively, the computing unit 310 may also be configured as an external computing unit. To this end, data communication between the external computing unit 310 and the vehicle 301, in which the states of the vehicle 301 or of the environment 312 determined by executing the model-based representation 311 on the sensor data 304 of the vehicle 301, can be provided to the vehicle 301 while traveling.

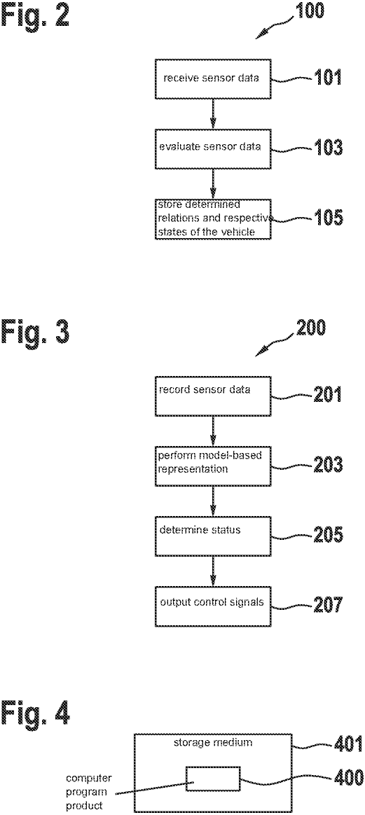

FIG. 2 shows a flow chart of a method 100 for generating a digital model-based representation 311 of a vehicle 301.

According to the present invention, in a first method step 101, sensor data 304 of a plurality of acoustic sensors 303 of the vehicle 301 are received. For this purpose, the sensor data 304 are recorded during a plurality of trips, for example, test trips, of the vehicle 301 along a plurality of different travel lanes 305. The sensor data 304 here describe vehicle sounds and environmental sounds 312 of the vehicle 301 and may additionally and/or alternatively include distance or speed information of objects 313 in the environment 312 of the vehicle 301.

In a further method step 103, the sensor data 304 are evaluated and relations between the recorded sounds of the sensor data 304 and the distance and speed information of the sensor data 304 and states of the vehicle 301 and states of the environment of the vehicle 301 are determined. To this end, state data 315 may be considered that include information regarding the particular states of the vehicle or the states of the environment 312 of the vehicle 301.

In a further method step 105, the relations between the sounds and/or the distance and speed information of the sensor data 304 and the states of the vehicle 301 and/or the states of the environment 312 of the state data 315 are stored in the corresponding model-based representation 311 of the vehicle 301.

FIG. 3 shows a flow chart of a method 200 for controlling a vehicle 301.

According to the present invention, in a first method step 201, sensor data 304 of a plurality of acoustic sensors 303 of the vehicle 301 are recorded while driving the vehicle 301.

In a further method step 203, a model-based representation 311 of the vehicle 301 generated according to the method 100 according to the present invention for generating a model-based representation 311 of a vehicle 301 is performed on the recorded sensor data 304.

In a further method step 205, by performing the model-based representation 311 of the vehicle 301 on the sensor data 304 of the acoustic sensors 301, at least one status of the vehicle 301 or one status of the environment 312 of the vehicle 301 is determined.

In a further method step 207, corresponding control signals are output based on the determined state of the vehicle 301 or the state of the environment 312 of the vehicle 301. The control signals are configured to control the vehicle 301 taking into account the determined states of the vehicle 301 and of the environment 312, respectively.

FIG. 4 shows a schematic illustration of a computer program product 400 comprising instructions that, when executed by a computing unit, cause the program to perform the method 100 for generating a digital model-based representation 312 of a vehicle 301 and/or the method 200 for controlling a vehicle 301.

The computer program product 400 in the shown embodiment is stored on a storage medium 401. The storage medium 401 can be any storage medium available in the related art.

What is claimed is:

1. A method of generating a digital model-based representation of a vehicle, comprising the following steps:
receiving sensor data of a plurality of acoustic sensors of the vehicle, wherein the sensor data describe sounds of the vehicle and/or sounds of an environment of the vehicle, and wherein the sensor data are recorded for a plurality of trips of the vehicle;
evaluating the sensor data and determining relations between: (i) the recorded sounds of the vehicle and/or of the environment, and (ii) respective states of the vehicle and/or of the environment causing the respective sounds; and
storing, in a model-based representation of the vehicle, the determined relations between the sounds of the vehicle and/or of the environment and the respective states of the vehicle and/or of the environment.

2. The method of claim 1, wherein the sounds of the vehicle include: sounds of a motor and/or a transmission and/or a chassis and/or a shock absorption and/or a wheel suspension and/or of brakes, and/or of tires and/or a body of the vehicle, and wherein the respective states of the vehicle include: functional states of the motor and/or the transmission and/or the chassis and/or the shock absorption and/or the wheel suspension and/or the tires and/or the body and/or a speed and/or a loading state of the vehicle and/or a rolling resistance of the tires on a travel lane and a state of the travel lane and/or a coating of the body with moisture or snow or dust or dust or leaves.

3. The method of claim 1, wherein the sounds of the environment include: sounds of further vehicles and/or sounds of pedestrians and/or sounds of animals and/or sounds of the vehicle reflected by buildings or vegetation situated in the environment and/or sounds of precipitation and/or sounds of snowfall and/or sounds of hail and/or sounds of wind, and wherein states of the environment of the vehicle include: a presence of vehicles and/or a presence of pedestrians and/or a presence of buildings and/or a presence of vegetation and/or a presence of precipitation and/or a presence of hail and/or a presence of snow.

4. The method of claim 3, further comprising detection of the objects in the environment including a position determination of the objects in the environment and/or a determination of a distance of the objects and/or a determination of a speed of the objects relative to the vehicle and/or a characterization of the objects.

5. The method of claim 1, wherein the sensor data include acoustic data of a plurality of microphones and/or data of a plurality of ultrasonic sensors.

6. The method of claim 1, wherein the determining of the relations between the sounds of the vehicle and/or of the environment and the respective states of the vehicle and/or of the environment includes performing machine learning techniques on the sensor data, and wherein the storing of the determined relations includes storing a correspondingly trained artificial intelligence or a plurality of correspondingly trained artificial intelligences.

7. The method of claim 1, wherein the model-based representation of the vehicle is formed as a digital twin of the vehicle based on the acoustic sensor data.

8. A method of controlling a vehicle, comprising the following steps:
receiving acoustic sensor data of a plurality of acoustic sensors of the vehicle, wherein the acoutsic sensor data describe sounds of the vehicle and/or sound of an environment of the vehicle;
executing a model-based representation of the vehicle on the acoustic sensor data, wherein the model-based representation of the vehicle is generated by:
receiving sensor data of a plurality of acoustic sensors of the vehicle, wherein the sensor data describe sounds of the vehicle and/or sounds of an environment of the vehicle, and wherein the sensor data are recorded for a plurality of trips of the vehicle,
evaluating the sensor data and determining relations between: (i) the recorded sounds of the vehicle and/or of the environment, and (ii) respective states of the vehicle and/or of the environment causing the respective sounds, and
storing, in the model-based representation of the vehicle, the determined relations between the sounds of the vehicle and/or of the environment and the respective states of the vehicle and/or of the environment;
determining a state of the vehicle and/or a state of the environment of the vehicle based on the acoustic sensor data of the vehicle and the relations stored in the model-based representation of the vehicle; and
outputting control signals for controlling the vehicle taking into account the determined state of the vehicle and/or the determined state of the environment of the vehicle.

9. A computing unit configured to generate a digital model-based representation of a vehicle, the computing unit configured to:
receive sensor data of a plurality of acoustic sensors of the vehicle, wherein the sensor data describe sounds of the vehicle and/or sounds of an environment of the vehicle, and wherein the sensor data are recorded for a plurality of trips of the vehicle;
evaluate the sensor data and determining relations between: (i) the recorded sounds of the vehicle and/or of the environment, and (ii) respective states of the vehicle and/or of the environment causing the respective sounds; and
store, in a model-based representation of the vehicle, the determined relations between the sounds of the vehicle and/or of the environment and the respective states of the vehicle and/or of the environment.

10. A computer-readable storage medium on which is stored a computer program for generating a digital model-based representation of a vehicle, the computer program, when executed by a data processor, causing the data processor to perform the following steps:
receiving sensor data of a plurality of acoustic sensors of the vehicle, wherein the sensor data describe sounds of the vehicle and/or sounds of an environment of the vehicle, and wherein the sensor data are recorded for a plurality of trips of the vehicle;
evaluating the sensor data and determining relations between: (i) the recorded sounds of the vehicle and/or of the environment, and (ii) respective states of the vehicle and/or of the environment causing the respective sounds; and
storing, in a model-based representation of the vehicle, the determined relations between the sounds of the vehicle and/or of the environment and the respective states of the vehicle and/or of the environment.
